(19) United States
(12) Patent Application Publication
(10) Pub. No.: US 2016/0047313 A1
(43) Pub. Date: Feb. 18, 2016

(54) BUSHING FOR JOINING TURBOMACHINE COMPONENTS

(71) Applicant: General Electric Company, Schenectady, NY (US)

(72) Inventors: Mark Carmine Bellino, Greenville, SC (US); Kevin Weston McMahan, Greer, SC (US); Lucas John Stoia, Taylors, SC (US); Christopher Paul Willis, Pickens, SC (US)

(21) Appl. No.: 14/460,470

(22) Filed: Aug. 15, 2014

(51) Int. Cl. F02C 7/20; F16B 43/00; F02C 3/04

(52) U.S. Cl. CPC F02C 7/20; F02C 3/04; F16B 43/00; F16B 2043/008

(57) ABSTRACT

A bushing includes a body extending from a first end to a second end through an intermediate portion. The body includes a passage having a first centerline extending from the first end to the second end. A first alignment member is formed on a first section of the intermediate portion at the first end. The first alignment member includes an outer surface having a plurality of splines configured to be received by a first component to be joined. A second alignment member is formed on a second section of the intermediate portion. The second alignment member includes a second centerline that is off-set relative to the first centerline and is configured to be received by a second component to be joined with the first component.

### BACKGROUND OF THE INVENTION

The subject matter disclosed herein relates to the art of turbomachines and, more particularly to a bushing for joining turbomachine components.

Turbomachines typically include a compressor portion and a turbine portion. The compressor portion forms a compressed airstream that is introduced into the turbine portion. In a gas turbomachine, a portion of the compressed airstream mixes with products of combustion forming a hot gas stream that is introduced into the turbine portion through a transition piece. The products of combustion are developed in a combustion chamber of a combustor. In the combustor, fuel and air may be passed through a nozzle to form a combustible mixture. The combustible mixture is combusted to form the products of combustion.

The hot gas stream impacts turbomachine airfoils arranged in sequential stages along the hot gas path. The airfoils are generally connected to a wheel which, in turn, may be connected to a rotor. Typically, the rotor is operatively connected to a load. The hot gas stream imparts a force to the airfoils causing rotation. The rotation is transferred to the rotor. Thus, the turbine portion converts thermal energy from the hot gas stream into mechanical/rotational energy that is used to drive the load. The load may take on a variety of forms including a generator, a pump, an aircraft, a locomotive, or the like. Generally, the transition piece is coupled to a combustor in which the products of combustion are developed.

### BRIEF DESCRIPTION OF THE INVENTION

According to one aspect of an exemplary embodiment, a bushing includes a body extending from a first end to a second end through an intermediate portion. The body includes a passage having a first centerline extending from the first end to the second end. A first alignment member is formed on a first section of the intermediate portion at the first end. The first alignment member includes an outer surface having a plurality of splines configured to be received by a first component to be joined. A second alignment member is formed on a second section of the intermediate portion. The second alignment member includes a second centerline that is off-set relative to the first centerline and is configured to be received by a second component to be joined with the first component.

According to another aspect of an exemplary embodiment, a turbomachine includes a compressor portion, a turbine portion operatively connected to the compressor portion, a combustor assembly including at least one combustor fluidically connected to each of the compressor portion and the turbine portion, a transition piece extending between the at least one combustor and the turbine, portion and a bushing mechanically linked to the transition piece and the turbine portion. The bushing includes a body extending from a first end to a second end through an intermediate portion. The body includes a passage having a first centerline extending from the first end to the second end. A first alignment member is formed on a first section of the intermediate portion at the first end. The first alignment member includes an outer surface having a plurality of splines received by a one of the turbine portion and the transition piece. A second alignment member is formed on a second section of the intermediate portion. The second alignment member includes a second centerline that is off-set relative to the first centerline and is received by the other of the turbine portion and the transition piece.

According to yet another aspect of an exemplary embodiment, a turbomachine system includes a compressor portion, a turbine portion operatively connected to the compressor portion, a combustor assembly including at least one combustor fluidically connected to each of the compressor portion and the turbine portion, a transition piece extending between the at least one combustor and the turbine portion, an air inlet system fluidically connected to an inlet of the compressor portion, a load operatively connected to one of the compressor portion and the turbine portion, and a bushing mechanically linked the transition piece and the turbine portion. The bushing includes a body extending from a first end to a second end through an intermediate portion. The body includes a passage having a first centerline extending from the first end to the second end. A first alignment member is formed on a first section of the intermediate portion at the first end. The first alignment member includes an outer surface having a plurality of splines received by one of the turbine portion and the transition piece. A second alignment member is formed on a second section of the intermediate portion. The second alignment member includes a second centerline that is off-set relative to the first centerline received by the other of the turbine portion and the transition piece.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a bushing, in accordance with an exemplary embodiment;

FIG. 2 is partial cross-sectional view of the bushing of FIG. 1 joining a transition piece to a turbine portion of the turbomachine;

FIG. 3 is a partial cross-sectional view of a joint between the transition piece and the turbine portion of FIG. 2;

FIG. 4 is a perspective view of the bushing, in accordance with an aspect of an exemplary embodiment;

FIG. 5 is an end view of the bushing of FIG. 4; and

FIG. 6 is a plan view of a first bushing mating with a second bushing, in accordance with another aspect of an exemplary embodiment.

The detailed description explains embodiments of the invention, together with advantages and features, by way of example with reference to the drawings.

### DETAILED DESCRIPTION OF THE INVENTION

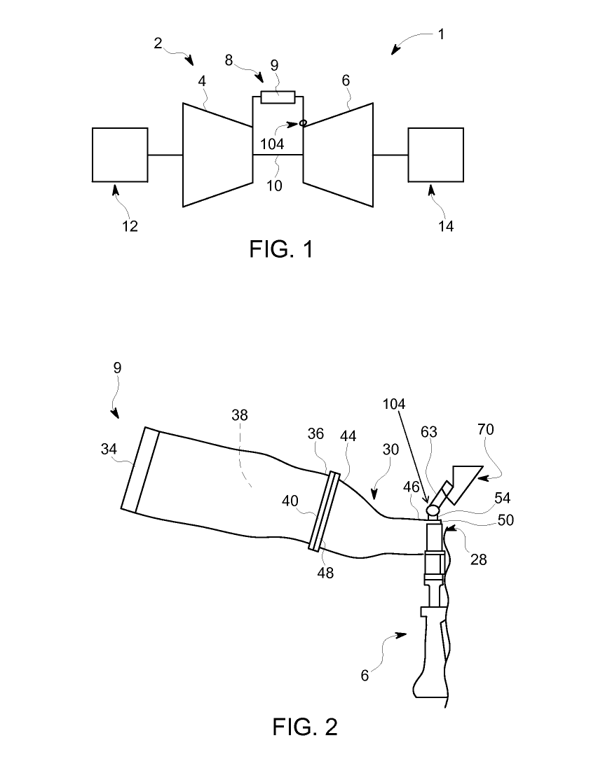

With initial reference to FIGS. 1 and 2, a turbomachine system is indicated generally at 1. Turbomachine system 1 includes a turbomachine 2 having a compressor portion 4 connected to a turbine portion 6 through a combustor assembly 8 including at least one combustor 9. Compressor portion 4 is also connected to turbine portion 6 via a common compressor/turbine shaft 10. An air inlet system 12 is fluidically connected to an inlet (not separately labeled) of compressor portion 4. A load, indicated generally at 14, is operatively connected to turbine portion 6. Load 14 may take on a variety of forms including generators, pumps, locomotive systems, and other driven loads. Turbine portion 6 may also be connected to an exhaust system (not shown).

With this arrangement, compressed air is passed from compressor portion 4 into combustor assembly 8. The compressed air is mixed with fuel and combusted to form hot gases. The hot gases are channeled to a stage 28 of turbine portion 6 via a transition piece 30. Turbine portion 6 converts thermal energy from the hot gases into mechanical/rotational energy. Additional compressed air may pass directly to turbine portion 6 for cooling. More specifically, combustor 9 extends from a head end 34 to an outlet 36 through a combustion chamber 38. Outlet 36 may include an outlet flange 40. Transition piece 30 extends from an inlet portion 44 to an outlet portion 46. Inlet portion 44 may include an inlet flange 48 mechanically linked to outlet flange 40.

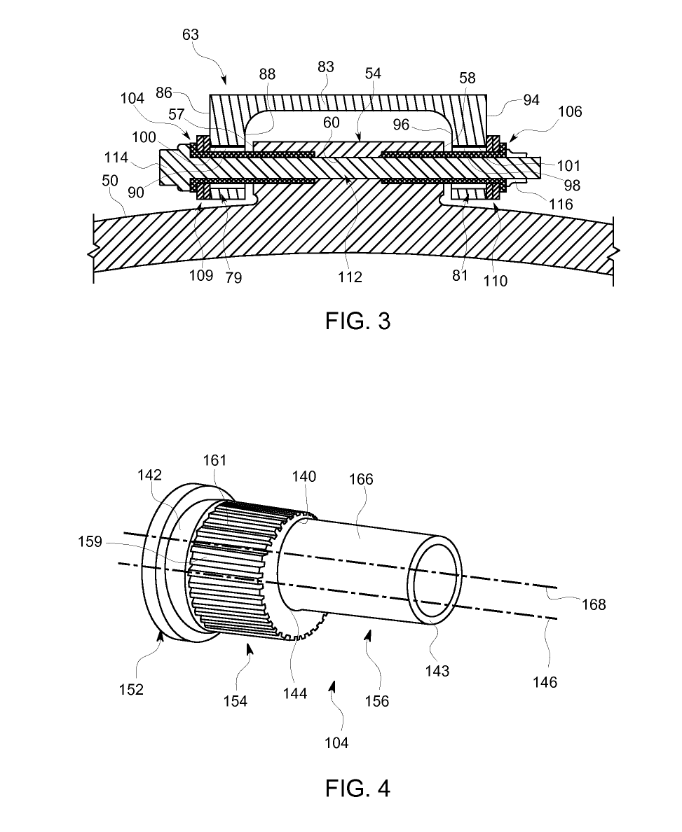

Outlet portion 46 may be connected to an outlet frame 50 that links transition piece 30 and turbine portion 6. Outlet frame 50 includes a flange 54. As shown in FIG. 3, flange 54 includes a first lateral end 57 and a second lateral end 58. A fastener passage 60 extends between first and second lateral ends 57 and 58. A bracket 63 is provided on a casing 70 of turbine portion 6. As will be detailed below, bracket 63 is mechanically linked to flange 54. Bracket 63 includes a first mounting member 79 and a second mounting member 81 joined by a web 83. First mounting member 79 includes a lateral outer surface 86 and a lateral inner surface 88. A first fastener journal 90 extends between lateral outer surface 86 and lateral inner surface 88. Similarly, second mounting member 81 includes a lateral outer surface 94 and a lateral inner surface 96. A second fastener journal 98 extends between lateral outer surface 94 and lateral inner surface 96. Each fastener journal 90, 98 includes a corresponding plurality of spline elements 100 and 101.

Often times, first and second fastener journals 90 and 98 are misaligned with fastener passage 60. In order to couple bracket 63 and flange 54 in such a case, turbomachine 2 includes a first bushing 104 that extends into first fastener journal 90 and fastener passage 60 and a second bushing 106 that extends into second fastener journal 98 and fastener passage 60. Bellville washers, such as shown at 109 and 110, may be arranged between respective ones of first and second bushings 104, 106, and first and second mounting members 79, 81. A mechanical fastener 112, shown in the form of a bolt 114, is passed through first and second bushings 104 and 106 and secured with a nut 116.

Reference will now follow to FIG. 4 in describing bushing 104 with an understanding that bushing 106 may include similar structure. Bushing 104 includes a body 140 extending from a first end 142 to a second end 143 through an intermediate portion 144. Body 140 includes a first centerline 146 and a flange 152 at first end 142. In accordance with an exemplary embodiment, body 140 includes a first alignment member 154 that defines a first section of intermediate portion 144 at first end 142 and a second alignment member 156 that defines a second section of intermediate portion 144 at second end 143.

First alignment member 154 includes an outer surface 159 having a plurality of splines 161. Splines 161 are arranged to engage with spline elements 100 in first mounting member 79. Inter-engagement of splines 161 and spline elements 100 establishes a desired relative rotational relationship of bushing 104 and first mounting member 79. Second alignment member 156 includes an annular outer surface 166 defining a circular cross-section having a second centerline 168 that is off-set relative to first centerline 146. More specifically, annular outer surface 166 is off-set relative to first alignment member 154. In this manner, bushing 104 can accommodate any misalignment of transition piece 30 and turbine portion 6.

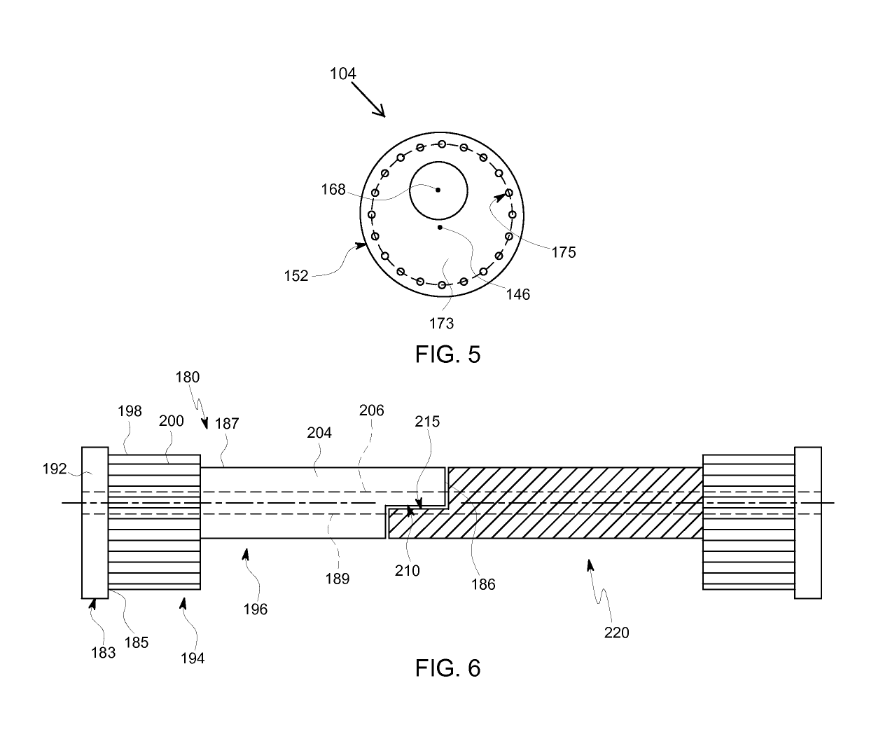

In accordance with an aspect of an exemplary embodiment illustrated in FIG. 5, flange 152 includes an outer face 173 provided with a plurality of indicators 175. Indicators 175 may be aligned with an indicator (not shown) on first mounting member 79 to facilitate joining flange 54 and bracket 63. More specifically, after determining a degree of misalignment between flange 54 and bracket 63, a bushing may be selected. The bushing may include a desired off-set of the second mounting member 81 relative to the first mounting member 79. The desired off-set may include a magnitude and direction that may accommodate the degree of misalignment between flange 54 and bracket 63. Further, the degree of off-set may include a selectable off-set range noted by indicators 175 for each bushing to accommodate the degree of misalignment. The selectable off-set range may extend between, for example, about 0.0-inches to about 0.200-inches (0.5-centimeters). Of course, it should be understood that the off-set range may vary. The desired off-set may be further indicated by one of indicators 175. Alignment of one of indicators 175 with an indicator on first mounting member 79 allows service personnel to ensure a desired clocking of, for example bushing 104 and bracket 63 to transition piece 30 and turbine portion 6.

FIG. 6 illustrates a bushing 180 in accordance with another aspect of an exemplary embodiment. Bushing 180 includes a body 183 extending from a first end 185 to a second end 186 through an intermediate portion 187. Body 183 includes a first centerline 189 and a flange 192 at first end 185. In accordance with an exemplary embodiment, body 183 includes a first alignment member 194 that defines a first section of intermediate portion 187 at first end 185 and a second alignment member 196 that defines a second section of intermediate portion 187 at second end 186.

First alignment member 194 includes an outer surface 198 having a plurality of splines 200. Splines 200 are arranged to engage with spline elements 100 in first mounting member 79. Inter-engagement of splines 200 and spline elements 100 establish a desired relative rotational relationship of bushing 180 and first mounting member 79. Second alignment member 196 includes an annular outer surface 204 having a second centerline 206 that is off-set relative to first centerline 189. As shown, second alignment member 196 includes a flat zone 210 formed at second end 186. Flat zone 210 establishes a half-moon shape geometry that may interface with a corresponding flat zone 215 on another bushing 220. In this manner, flat zones 210 and 215 establish a desired keyed relationship between bushings 180 and 220.

At this point it should be understood that the exemplary embodiments describe a bushing(s) that may be employed to join to misaligned components. The bushing includes a first alignment member having a spline that interfaces with one of the components and a second alignment member that is off-set relative to the first alignment member and joins with the second component. The degree of off-set may vary and multiple bushings of varying degrees of off-set may be available for an installation. Further, while shown in terms of joining a transition piece and a turbine portion of a turbomachine, the bushings may be employed to join and align any two components.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A bushing comprising:
a body extending from a first end to a second end through an intermediate portion, the body including a passage having a first centerline extending from the first end to the second end;
a first alignment member formed on a first section of the intermediate portion at the first end, the first alignment member including an outer surface having a plurality of splines configured to be received by a first component to be joined; and
a second alignment member formed on a second section of the intermediate portion, the second alignment member including a second centerline that is off-set relative to the first centerline and being configured to be received by a second component to be joined with the first component.

2. The bushing according to claim 1, wherein the second alignment member includes an annular outer surface off-set relative to the outer surface of the first alignment member.

3. The bushing according to claim 1, further comprising: a flange arranged at the first end, the flange including a plurality of indicators that correspond to respective ones of the plurality of splines.

4. The bushing according to claim 1, wherein the second alignment member includes a circular cross-section.

5. The bushing according to claim 4, wherein the second alignment member includes a flat zone at the second end, the flat zone being configured and disposed to matingly engage with another bushing.

6. A turbomachine comprising:
a compressor portion;
a turbine portion operatively connected to the compressor portion;
a combustor assembly including at least one combustor fluidically connected to each of the compressor portion and the turbine portion;
a transition piece extending between the at least one combustor and the turbine portion; and
a bushing mechanically linking the transition piece and the turbine portion, the bushing comprising:
a body extending from a first end to a second end through an intermediate portion, the body including a passage having a first centerline extending from the first end to the second end;
a first alignment member formed on a first section of the intermediate portion at the first end, the first alignment member including an outer surface having a plurality of splines received by one of the turbine portion and the transition piece; and
a second alignment member formed on a second section of the intermediate portion, the second alignment member including a second centerline being off-set relative to the first centerline received by the other of the turbine portion and the transition piece.

7. The turbomachine according to claim 6, wherein the second alignment member includes an annular outer surface off-set relative to the outer surface of the first alignment member.

8. The turbomachine according to claim 6, further comprising: a flange arranged at the first end, the flange including a plurality of indicators that correspond to respective ones of the plurality of splines.

9. The turbomachine according to claim 6, wherein the second alignment member includes a circular cross-section.

10. The turbomachine according to claim 9, wherein the second alignment member includes a flat zone at the second end, the flat zone being configured and disposed to matingly engage with another bushing.

11. A turbomachine system comprising:
a compressor portion;
a turbine portion operatively connected to the compressor portion;
a combustor assembly including at least one combustor fluidically connected to each of the compressor portion and the turbine portion;
a transition piece extending between the at least one combustor and the turbine portion;
an air inlet system fluidically connected to an inlet of the compressor portion;
a load operatively connected to one of the compressor portion and the turbine portion; and
a bushing mechanically linking the transition piece and the turbine portion, the bushing comprising:
a body extending from a first end to a second end through an intermediate portion, the body including a passage having a first centerline extending from the first end to the second end;
a first alignment member formed on a first section of the intermediate portion at the first end, the first alignment member including an outer surface having a plurality of splines received by one of the turbine portion and the transition piece; and
a second alignment member formed on a second section of the intermediate portion, the second alignment member including a second centerline being off-set relative to the first centerline and being received by the other of the turbine portion and the transition piece.

12. The turbomachine system according to claim 11, wherein the second alignment member includes an annular outer surface off-set relative to the outer surface of the first alignment member.

13. The turbomachine system according to claim 11, further comprising: a flange arranged at the first end, the flange including a plurality of indicators that correspond to respective ones of the plurality of splines.

14. The turbomachine system according to claim 11, wherein the second alignment member includes a circular cross-section.

15. The turbomachine system according to claim 14, wherein the second alignment member includes a flat zone at the second end, the flat zone being configured and disposed to matingly engage with another bushing.
